(19) United States
(12) Patent Application Publication
(10) Pub. No.: US 2026/0203506 A1
(43) Pub. Date: Jul. 16, 2026

(54) SYSTEMS AND METHODS FOR SURFACING INFORMATION

(71) Applicant: REGDESK, Inc., Houston, TX (US)

(72) Inventors: Jixian WANG, Odessa (UA); HaiBiao Deng, Guangdong (CN); Priyanka Paul Bhutani, Houston, TX (US)

(21) Appl. No.: 19/064,501

(22) Filed: Feb. 26, 2025

(30) Foreign Application Priority Data
Jan. 15, 2025 (CN) 202510062159.4

(51) Int. Cl. G06F 40/30

(52) U.S. Cl. CPC G06F 40/30

(57) ABSTRACT

Systems, methods, and devices for surfacing relevant information from large datasets and electronic document collections using advanced natural language processing (NLP) techniques and machine learning algorithms. Electronic documents including text data may be received in multiple formats (e.g., DOC, PDF, HTML). The text data may be processed using a pre-trained NLP model to extract semantic content, and high-dimensional embeddings representing the context and meaning of the text may be generated. The embeddings may be stored in a vector database, enabling fast and efficient retrieval based on similarity algorithms. The surfaced information may be used for tasks such as form completion, generating natural language summaries, and automating document management.

### CROSS-REFERENCE TO RELATED APPLICATIONS

This application claims the benefit of, and priority to, Chinese Patent Application No. 202510062159.4, filed Jan. 15, 2025, and entitled “SYSTEMS AND METHODS FOR SURFACING INFORMATION,” the disclosure of which is incorporated by reference in its entirety as if the same was fully set forth herein.

### TECHNICAL FIELD

The present disclosure generally relates to information retrieval systems and methods, and more particularly to surfacing relevant information from large datasets and electronic document collections. According to some aspects, the present disclosure pertains to systems and methods employing natural language processing (NLP) techniques and advanced machine learning algorithms to extract, analyze, and surface semantically relevant content from unstructured and structured text data, enabling improved document management, information retrieval, and automated responses in various industries including legal, medical, and financial sectors.

### BACKGROUND

In various industries, the effective management and retrieval of information from large datasets and collections of electronic documents are critical to operational success. Conventional methods of document management typically involve manual searching, sorting, and classification of documents based on metadata or keywords, which can be time-consuming and prone to errors. As the volume of digital information continues to grow, these conventional approaches struggle to scale efficiently, often resulting in incomplete, inaccurate, or delayed access to relevant information.

Organizations in fields such as healthcare, finance, legal, and regulatory compliance often deal with vast amounts of unstructured or semi-structured data. Extracting relevant insights from these large and complex datasets is challenging. For example, legal firms must review vast repositories of contracts, case law, and regulations, while healthcare providers must sift through patient records, research articles, and insurance documentation. In both scenarios, retrieving precise and contextually relevant information is crucial for decision-making, compliance, and maintaining efficiency.

Current document management systems typically rely on rudimentary search functions that depend on keyword matching or manually assigned metadata. However, such systems often fail to capture the semantic meaning or context of the data, limiting the accuracy of the information surfaced during searches. As a result, users spend excessive time manually reviewing documents or retrieving irrelevant or outdated data.

Accordingly, there is a growing need for advanced systems that can automatically surface relevant information from large datasets based on the semantic content of the documents. Such systems would improve efficiency, reduce human error, and enable organizations to better handle the increasing complexity of modern data management.

Accordingly, there is a need for a more advanced document management system that can automatically and accurately manage, classify, and retrieve content from electronic files.

This background information is provided to reveal information believed by the applicant to be of possible relevance. No admission is necessarily intended, nor should be construed, that any of the preceding information constitutes prior art.

### SUMMARY

Briefly described, and in various embodiments, the present disclosure generally relates to information retrieval, specifically within the context of surfacing information from large datasets and electronic documents.

The present disclosure provides systems and methods for efficiently surfacing relevant information from large datasets and collections of electronic documents. According to some aspects, Natural Language Processing (NLP) models may be trained on domain-specific text data and may be combined with advanced machine learning algorithms to manage and extract semantically relevant content from unstructured and structured text data. The present disclosure may improve upon conventional document management systems that rely on metadata-based or keyword-based searches, which often fail to capture the true meaning and context of data, especially when dealing with large and complex datasets.

A plurality of electronic documents may be received from various data sources, which may include documents in formats such as DOC, PDF, HTML, and/or scanned images. The electronic documents may be processed by a pre-trained NLP model, which may extract semantic meaning from the text data. The NLP model may be trained on a dataset comprising domain-specific text, ensuring that it recognizes and processes terminology and concepts specific to a given industry, such as healthcare, legal, financial, or regulatory sectors.

High-dimensional embeddings for the document text data may be determined based on the semantic meaning. The embeddings may represent the semantic content in a numerical format, allowing for efficient comparison and retrieval of relevant information. The embeddings may be stored in a vector database, optimized for high-speed queries using similarity algorithms. Thereby the most contextually relevant information may be surfaced from the dataset.

The surfaced semantic meaning of document text data may be transmitted to one or more internal system, external systems, or user interfaces for further actions. For example, the surfaced information can be used to automate the completion of regulatory forms, such as an electronic Submission Template and Resource (eSTAR) form, or populate other structured documents. The surfaced content may also be displayed to users for review, e.g., ranked by relevance based on similarity scores between the query and the document text. Additionally, the system may suggest further actions, such as recommending additional documents based on the surfaced information or providing natural language summaries of key content slices.

The NLP model may be continuously updated and refined using feedback from users, allowing the NLP model to improve its accuracy over time. Moreover, multi-language document processing may be supported, enabling semantically relevant content to be surfaced from documents in various languages.

By addressing technical limitations of traditional document management systems and offering a more nuanced and context-aware approach to information retrieval, the present disclosure may provide a robust solution for industries that require rapid and accurate access to relevant data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of an environment for a document management system;

FIG. 2 illustrates an exemplary schematic representation of a Natural Language Processing (NLP) model;

FIG. 3 illustrates an exemplary schematic representation of a dataset;

FIG. 4 illustrates an exemplary electronic document;

FIG. 5 illustrates an exemplary data process flow;

FIG. 6 illustrates an exemplary entity relationship diagram;

FIG. 7 illustrates an exemplary data query sequence;

FIG. 8 illustrates an exemplary data input sequence;

FIG. 9 illustrates an exemplary process;

FIG. 10 illustrates a schematic of an exemplary device; and

FIG. 11 illustrates an exemplary diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

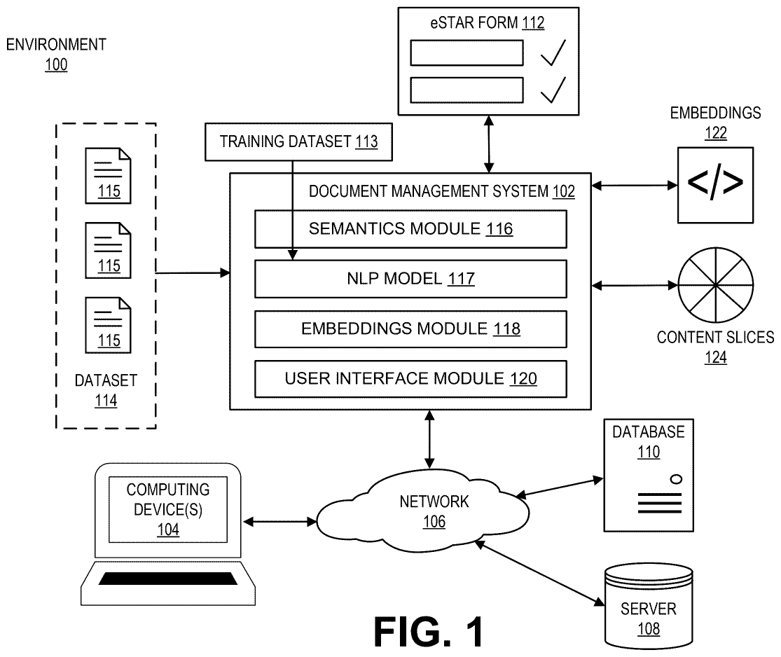

Referring now to the figures, for the purposes of example and explanation of the processes and components of the disclosed systems and methods, reference is made to FIG. 1, which illustrates an example environment 100 for a document management system 102 designed to surface information from one or more datasets 114 (e.g., including electronic documents 115) and facilitate the efficient handling and processing of electronic documents 115. The environment 100 may include various components such as one or more computing devices 104, a network 106, a server 108, and a database 110, each of which may interact to support the functionality of the document management system 102.

The document management system 102 may receive a plurality of electronic files 115. The electronic files 115 may be in various formats, including DOC, PDF, HTML, and/or scanned images. Moreover, the document management system 102 may provide scalability and reliability by managing files stored across different locations, including one or more distributed databases. The document management system 102 may include one or more modules, such as a semantics module 116 (e.g., including a natural language processing model 117), an embeddings module 118, and a user interface (UI) module 120.

The semantics module 116 may extract semantic information from the electronic files 115 using a pre-trained natural language processing (NLP) model 117. The semantics module 116 may ingest the contents of various document formats associated with the electronic files 115 (e.g., DOC, PDF, HTML, or scanned images). For scanned images, the semantics module 116 may employ optical character recognition (OCR) to convert the image-based text into machine-readable text.

The NLP model 117 (e.g., a machine learning model) may process the text to understand the context and meaning of the content. The NLP model 117 may include one or more machine learning models. The NLP model 117 may process, understand, and/or generate human language by analyzing text to discern patterns, extract meaning, and perform tasks such as translation, summarization, question answering, and/or content categorization. The NLP model 117 may be coded using one or more programming languages, such as Python. Moreover, the NLP model 117 may use one or more machine learning libraries, such as TensorFlow or PyTorch. The machine learning libraries may provide tools for defining the architecture of the model (e.g., neural networks), training it on large datasets, and fine-tuning its performance.

According to some aspects, the NLP model 117 may utilize deep learning techniques and may utilize one or more transformer architectures (e.g., BERT, GPT, etc.) to understand the context of words in a sequence. The transformer models may use layers of attention mechanisms to learn relationships between different parts of the text, allowing the NLP model 117 to capture both short-term and long-term dependencies in sentences. According to some aspects, the transformer models may include sequence-based models, such as recurrent neural networks (RNNs) and/or long short-term memory (LSTM) networks.

According to some aspects, the NLP model 117 may employ a self-attention mechanism. The self-attention mechanism may allow the transformer architecture(s) to process the entire input sequence at once, rather than one token at a time (e.g., as in RNNs). Thereby the transformer architecture(s) may capture both local and global dependencies in text more efficiently, regardless of the distance between words or phrases.

For example, input text may be tokenized and passed through an embedding layer, where each word or subword may be mapped to a vector in a high-dimensional space. The embeddings may be fed into multi-head attention layers of the transformer architecture. The multi-head attention layers may allow the NLP model 117 to focus on different parts of the text simultaneously, learning which words are most relevant to each other. For example, in the sentence “The lawyer argued the case in court,” the transformer may learn that “lawyer” is related to “court” even though several words separate them. This ability to “attend” to distant but related words may enhance the NLP model's ability to provide contextual understanding.

The transformer may include an encoder-decoder structure or may be used as an encoder-only or decoder-only model, depending on the task. For language understanding tasks like classification, a BERT (Bidirectional Encoder Representations from Transformers) may use the encoder part of the transformer to analyze the text bidirectionally. For example, the BERT may read the entire sequence of words in both directions (e.g., left to right and/or right to left), which may allow the NLP model 117 to understand the full context of each word. For example, the word “bank” in “riverbank” may be interpreted differently from “bank” in “financial bank” based on the context provided by the surrounding words. For text generation, a GPT (Generative Pre-trained Transformer) may utilize a decoder part of the transformer. For example, the GPT may process text unidirectionally, predicting the next word in a sequence based on a context of the previous words. According to some aspects, the GPT may be used to generate human-like text, answer questions, or summarize documents.

According to some aspects, the transformers may use self-attention to compute a weighted average of the embeddings at each position. The weights may be determined by determining attention scores, e.g., how much focus one word should place on every other word in the sequence. The attention scores may be calculated using one or more metrics, e.g., query, key, and/or value matrices. For each word, the query vector may interact with vectors from all other words to generate an attention score. The attention score may be applied to the value vectors to produce a context-aware representation of the word. Thereby, the multi-head mechanism may allow the NLP model 117 to learn different relationships within the text concurrently, improving its ability to capture subtle nuances. For example, when processing a legal document, a transformer-based NLP model may recognize relationships between terms like “contract,” “party,” and “termination clause” even if they are spread across different parts of an electronic document 115. Moreover, capturing long-range dependencies may be beneficial for tasks such as contract analysis, legal research, and/or case law retrieval.

The NLP model 117 may be trained on a training dataset 113 comprising domain-specific text data. The training dataset 113 may include a diverse range of text from a particular domain, such as legal contracts, medical research papers, financial reports, or regulatory filings. The NLP model 117 may leverage the training dataset 113 to learn linguistic patterns, terminology, and/or contextual relationships specific to the chosen domain. For example, in a legal context, the model may be trained on documents that contain key terms like “contract,” “breach,” “liability,” and “agreement,” with an understanding of how these terms interact and vary in meaning depending on their context within legal texts.

To train the NLP model 117, a multi-phase process may include pre-training the NLP model 117 on training dataset 113 (e.g., including a large corpus of general text data), which may help the NLP model 117 develop a foundational understanding of language. A pre-training phase may include one or more techniques such as masked language modeling or next-sentence prediction, which may allow the NLP model 117 to understand grammar, syntax, and basic linguistic constructs. For example, transformer-based architectures like BERT may be used to pre-train the NLP model 117, which may capture context by analyzing both the preceding and succeeding text around a word or phrase.

According to some aspects, the NLP model 117 may be pre-trained on large corpora of text (e.g., Wikipedia, news articles, electronic documents, etc.) to learn general language patterns, followed by fine-tuning on domain-specific datasets, such as legal, medical, or financial documents, to specialize the NLP model 117 in a particular field. The training process may include unsupervised learning techniques such as masked language modeling (MLM) or autoregressive modeling, e.g., where the NLP model 117 may learn to predict missing or next words in a sequence. In fine-tuning, supervised learning techniques may be employed, where the NLP model 117 may be trained on labeled data to enhance its performance in domain-specific tasks. For example, the NLP model 117 may be trained on legal text data and may be fine-tuned to surface key information from contracts, such as “termination clauses” or “payment obligations,” even when those phrases are not explicitly mentioned but are implied by the context.

During training, the NLP model 117 may utilize backpropagation to adjust its internal weights based on the accuracy of its predictions. Advanced optimization algorithms, such as Adam or RMSProp, may refine one or more parameters of the NLP model 117, ensuring that the NLP model 117 converges to a state where it accurately interprets the meaning of domain-specific texts. According to some aspects, the training process may be iterative. For example, the NLP model 117 may continually adjust its weights through gradient descent based on a loss function that measures the difference between the predicted output and the true labels.

Furthermore, the training process may include embedding techniques such as word embeddings or contextual embeddings, where words or phrases may be represented as vectors in a high-dimensional space. The embeddings may capture a semantic meaning of the text, allowing the NLP model 117 to determine relationships between words based on their proximity in the vector space. For example, in a financial context, terms such as “revenue,” “profit,” and “earnings” may be positioned closer together, while terms unrelated to finance may be further apart.

By training the NLP model 117 on a domain-specific dataset, highly relevant information may be surfaced from electronic documents with increased precision. The NLP model 117 may identify key terms and may understand their contextual meaning and relevance based on the specific industry, thereby offering a sophisticated and accurate information retrieval system. Once trained, the NLP model 117 may process the received electronic documents 114, extracting high-dimensional semantic embeddings that represent the contextual meaning of the text. For example, if the text pertains to legal documents, the NLP model 117 may differentiate between legal terms such as “contract” and “agreement,” understanding their relationships and implications in the broader context of the document.

According to some aspects, the NLP model 117 may tokenize text, breaking it down into words or subwords, e.g., depending on the granularity of the analysis. The NLP model 117 may pass the tokens through an embedding layer, which may map each token to its corresponding vector in a high-dimensional space. The NLP model 117 may then apply several attention layers (or transformer layers), which may enable the NLP model 117 to focus on different parts of the text and capture dependencies between tokens. The NLP model 117 may output its predictions or embeddings, which may be used for tasks such as classification (e.g., categorizing a document as legal or medical), information extraction (e.g., identifying named entities like people or organizations), or generating new text based on the input.

For example, the NLP model 117 may extract key provisions from contracts, such as the “termination clause.” The NLP model 117 may be trained to understand not just the words in the document but their legal significance, allowing it to identify sections that define the termination conditions of a contract, even if they are phrased in different ways. The NLP model 117 may provide a sophisticated tool that processes human language and learns to recognize patterns and relationships within text to perform various language-related tasks. An ability of the NLP model 117 to understand context and meaning may be particularly important in one or more fields, including legal, medical, and financial document analysis, where precise language interpretation may be critical.

Once the text is accessible, the NLP model 117 may process the text to understand the context and meaning of the content. The processing may include tokenizing the text into smaller units, such as words and sentences, and then applying syntactic and semantic analysis to identify relationships between these units. The NLP model 117 may generate a detailed representation of the text's semantic structure. For example, if the electronic file 115 contains a research article, the semantics module 116 may identify key components such as the title, abstract, introduction, methods, results, and conclusions. Training the NLP model 117 on diverse datasets may enable it to make these distinctions accurately, ensuring that the extracted semantic information is both relevant and precise.

The embeddings module 118 may generate embeddings 122 by converting the semantic information extracted by the semantics module 116 into numerical representations that capture the contextual meaning of the text. For example, the semantics module 116 may use advanced techniques such as word embeddings and sentence embeddings, which may be created through neural network models such as Word2Vec, GloVe, or BERT. The models may be pre-trained on large corpora of text data and may understand complex linguistic patterns and relationships. The embeddings module 118 may process each text segment, encoding the semantic information into high-dimensional vectors. Each vector may be a point in a multi-dimensional space, where semantically similar texts are positioned closer together, facilitating efficient comparison and retrieval.

For example, consider a segment from a legal document that discusses “intellectual property rights.” The embeddings module 118 may generate a high-dimensional vector for this text, capturing its semantic nuances. This vector may have multiple dimensions, each representing different aspects of the text's meaning. Dimensions may encode various features such as syntactic structure, contextual relevance, and domain-specific terminology. If another document segment discusses “patent laws,” the generated vector may be close to the “intellectual property rights” vector in the high-dimensional space, reflecting their semantic similarity. This numerical format may allow the document management system to perform rapid searches and comparisons across large datasets. For instance, when a user queries the document management system 102 for information related to intellectual property, the embeddings module 118 may quickly compare a query vector with stored vectors, ensuring accurate and contextually appropriate results.

The document management system 102 may segment the electronic files 115 into a plurality of content slices 124 based on the extracted semantic information using a sophisticated text analysis process. The document management system 102 may perform a sliding window method, where the text may be divided into overlapping segments to ensure that the context is preserved across segment boundaries. For example, a window size of 200 words with a 50-word overlap may prevent important sentences or phrases that span across segments from being fragmented. Utilization of the sliding window may maintain the semantic integrity of the content slices 124, allowing each segment to be understood within its broader context.

Once the text is divided into initial segments, the document management system 102 may apply the pre-trained NLP model 117 to analyze the semantic content of each segment. The document management system 102 may evaluate the semantic similarity between adjacent segments to decide if they should be merged or kept separate. For instance, if two adjacent segments discuss closely related topics, the document management system 102 may merge them into a single content slice 124 to avoid losing semantic coherence. Each finalized content slice 124 may then associated with an embedding 122 generated by the embeddings module 118. For example, in a research paper, the document management system 102 may segment the text into content slices 124 representing the introduction, methodology, results, and conclusion, each associated with an embedding 122 that encapsulates its specific content. This segmentation process may ensure that the document's meaning is preserved and accessible for computational analysis, facilitating accurate and context-aware searches within the document management system 102.

Moreover, the document management system 102 may include version control mechanism for each content slice 124 stored in the database 110. The version control may enable users to track changes made to the content slices 124 over time, including modifications, approvals, or deletions. Each version of a content slice 124 may be stored as a separate entry in the database 110, preserving the historical context of the data. This functionality may be important in regulatory environments where maintaining a detailed audit trail is essential for compliance purposes. Users interacting with the system via the UI module 120 may view the version history of any content slice 124, compare different versions, and, if necessary, revert to a previous version. The version control may help users and/or the document management system 102 to determine that the most accurate and relevant data is used during the completion of the eSTAR form 112.

The document management system 102 may store the content slices 124 and their corresponding embeddings 122 in a database 110 to facilitate efficient retrieval and management of document data. Once the content slices 124 are generated and associated with their respective embeddings 122, the document management system 102 may prepare the content slices 124 and their respective embeddings 122 for storage by organizing the data into a structured format suitable for the database 110. Each content slice 124, along with its embedding 122, may be indexed and labeled with metadata tags that include references to the original electronic file, the segment's position within the electronic file 115, and other relevant attributes.

The database 110 may enable rapid and accurate searches by handling large volumes of high-dimensional data. The database 110 may utilize advanced indexing techniques such as k-d trees or R-trees to organize the high-dimensional vectors efficiently. When storing the content slices 124 and embeddings 122, the document management system 102 may maintain the spatial relationships of the vectors, allowing for optimized similarity searches. For instance, when a query is processed, the database 110 may quickly locate and retrieve the most relevant content slices 124 based on the proximity of their embeddings 122 to the query embedding. This organization may allow the document management system 102 to perform complex queries and comparisons across extensive datasets, providing users with precise and contextually relevant results. Additionally, the database 110 may support encryption of the content slices 124 before storage, enhancing data security and ensuring that sensitive information is protected. This secure and efficient storage mechanism may maintain the integrity and accessibility of the vast and semantically rich dataset of the document management system 102.

The eSTAR form 112 may include a standardized template (e.g., for various regulatory and administrative applications) that collects, organizes, and processes a wide range of data from multiple electronic documents. The eSTAR form 112 may be associated with one or more industries requiring documentation and regulatory compliance, such as healthcare, legal, or finance. The eSTAR form 112 may include one or more structured data fields or intelligent prompts to accurately capture and organize all necessary information, reducing errors and omissions that can occur with traditional forms. Additionally, the eSTAR form 112 may support collaborative editing, allowing multiple users to work on the eSTAR form 112 simultaneously, and may include features for user approval and version control, thereby enhancing the overall efficiency and reliability of the submission process.

The document management system 102 may increase functionality of the eSTAR form 112 by automating one or more aspects of form completion. The document management system 102 may extract relevant data from various document formats associated with the electronic files 115 (e.g., DOC, PDF, HTML, or scanned images) and segment the data into content slices 124 associated with embeddings 122. These embeddings 122 may be matched with the corresponding sections of the eSTAR form 112, e.g., using an optimized similarity algorithm. Thereby the document management system 102 may expedite form completion and automatically complete the eSTAR form with information that is contextually accurate and relevant.

The document management system 102 may receive indications of one or more sections of the eSTAR form 112, e.g., through interactions facilitated by the UI module 120. The UI module 120 may provide a user-friendly interface on the computing device 104, allowing users to interact with the document management system 102 intuitively. For example, the interface may display the eSTAR form 112 in a structured manner, breaking it down into various sections such as personal information, project details, compliance data, etc. Users may navigate through these sections using interactive elements such as clickable buttons, dropdown menus, and text input fields. By selecting or highlighting specific sections of the eSTAR form 112, users may indicate which parts they are focusing on or need assistance with.

Once the user indicates a section through the UI, the UI module 120 may capture the input and may format the input for further processing by the document management system 102. For example, if a user selects the “Project Details” section, the UI module 120 may generate a corresponding query or command that specifies the “Project Details” section. The embeddings module 118 may convert the user's indication into one or more query embeddings using the pre-trained NLP model, effectively capturing the semantic intent of the input. The embeddings 122 may be used to search the database 110 for relevant content slices 124 that match the specified section of the eSTAR form 112. This interaction between the user, the UI module 120, and the backend components of the document management system 102 may provide a seamless and efficient workflow, enabling accurate and contextually appropriate data retrieval for form completion.

The document management system 102 may convert the indication of the one or more sections of the eSTAR form 112 into one or more embeddings 122 using the NLP model 117. When a user or a computing device 104 indicates a specific section of the eSTAR form 112, the input may be processed by the embeddings module 118. For example, the embeddings module 118 may leverage the NLP model to understand the semantic context and intent behind the user's indication. For example, if the user selects the “Project Details” section, the document management system 102 may interpret the input to mean that information related to project specifics, such as objectives, scope, and timelines, is required.

The embeddings module 118 may generate embeddings 122 that capture the semantic essence of the indicated section. Generating the embeddings 122 may include encoding the textual description of the form section into numerical vectors using the NLP model 117. The vectors and/or embeddings 122 may represent the meaning and context of the user's input in a format that can be used for computational analysis. The embeddings 122 may be comparable in a high-dimensional space, where similar meanings may result in vectors that are close to each other. For example, if the section indicated is related to “financial details,” the embeddings 122 may reflect financial terminology and context. The embeddings 122 associated with the query may be used to search the database 110 for content slices 124 that match the intended information, facilitating retrieval of the most relevant and contextually accurate data to populate the eSTAR form 112. This conversion process may allow the document management system 102 to efficiently and accurately understand and respond to user queries, leveraging the power of advanced NLP techniques.

The document management system 102 may determine one or more content slices 124 by searching the database 110 for the embeddings 122 generated based on the user's indication of the sections of the eSTAR form 112. When the embeddings module 118 converts the user's input into embeddings 122, the embeddings 122 may encapsulate the semantic intent and context of the required information. The database 110, which may store content slices 124 along with their corresponding embeddings 122, may be searched using these embeddings 122. The search process may include comparing the embeddings 122 to the embeddings stored in the database 110 to identify content slices 124 that are semantically similar.

A search algorithm employed by the document management system 102 may use optimized similarity algorithms, such as approximate nearest neighbor (ANN) techniques, to efficiently locate the most relevant content slices 124. The similarity between embeddings 122 may be measured by calculating the distance between the query embeddings and the stored embeddings in the high-dimensional space. Content slices 124 with embeddings that are closest to the query embeddings may be deemed the most relevant. For instance, if the query embedding represents a request for “project timelines,” the document management system 102 may retrieve content slices containing information about project schedules and deadlines. Additionally, the document management system 102 may generate a confidence score for each identified content slice, indicating the relevance of the content slice to the query embeddings. Therefore, the most contextually appropriate and accurate data may be selected to populate the eSTAR form 112, enhancing the overall efficiency and reliability of the document management process.

The document management system 102 may transmit the identified content slices 124 to the one or more computing devices 104 or directly to a user operating the computing devices 104. For example, the document management system 102 may provide the identified content slices 124 as filled-in sections of the eSTAR form 112. Once the document management system 102 determines the most relevant content slices 124 based on the embeddings 122, the document management system 102 may compile the content slices 124 into a structured format suitable for form completion. The filled-in sections may be generated by inserting the content slices 124 into the appropriate fields of the eSTAR form 112, ensuring that each section of the eSTAR form 112 is accurately populated with the corresponding data extracted from the electronic files 115.

The transmission process may be facilitated by the UI module 120, which may manage the interaction between the document management system 102 and the user interface on the computing devices 104. The UI module 120 may display the filled-in sections of the eSTAR form 112 in an organized and user-friendly manner. Moreover, the interface provided by the UI module 120 may allow users to manually refine or correct the extracted content slices before they are inserted into the eSTAR form 112. The document management system 102 may also receive approval of the content slices and update the database 110 based on this approval, ensuring the accuracy and relevance of the stored data. For example, the eSTAR form may be presented on the user's screen with highlighted fields indicating the newly inserted content slices 124. Users may review the filled-in sections, make any necessary adjustments, or provide approval for the completed form. The document management system 102 can also handle various data formats, providing compatibility with the user's device and software. This seamless transmission and integration process may automate the form completion task, reducing manual effort, and providing information that is both accurate and contextually relevant.

According to some aspects, the document management system 102 may integrate with other document management systems to facilitate the import and export of electronic files 115. This integration may facilitate data exchange between different platforms, ensuring that electronic files 115 associated with the eSTAR form 112 can be easily transferred between systems without requiring manual intervention. For example, the electronic files 115 may be stored in a cloud-based system. The document management system 102 may utilize API-based communication to retrieve the electronic files 115 for processing by the semantics module 116 and/or the embeddings module 118. This interoperability may enhance the flexibility of the document management system 102 and allow it to function within diverse IT ecosystems.

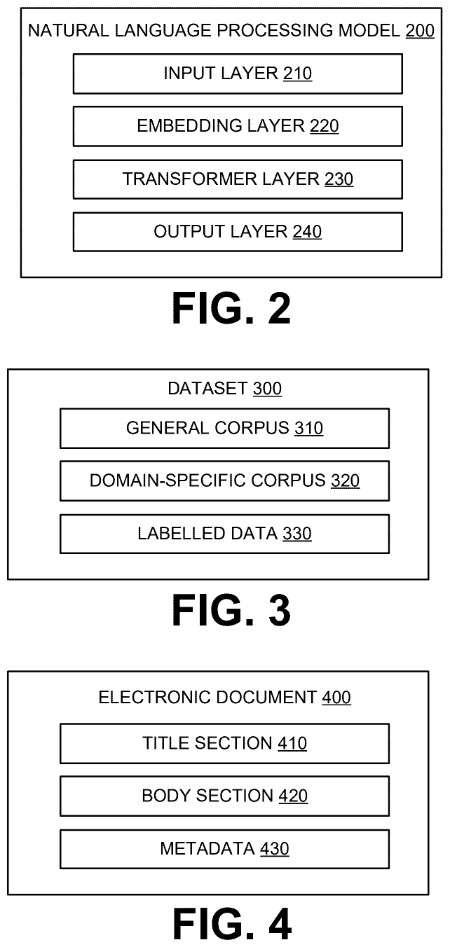

As illustrated in FIG. 2, the NLP Model 200 may be used to surface relevant information from electronic documents 202. The NLP Model 200 may include a machine learning system. The machine learning system may process and understand text by generating semantic representations. The NLP Model 200 may include one or more layers, including an input layer 210, an embedding layer 220, a transformer layer 230, and an output layer 240.

The input layer 210 of the NLP Model 200 may process raw text data from various sources, including electronic documents and datasets. For example, the input layer 210 may handle unstructured text, such as text from one or more of legal documents, medical reports, financial statements, or other domain-specific content. The input layer 210 may convert the raw text into a format that may be further processed by the other layers of the NLP model 200. The input layer 210 may process the text through tokenizing. Tokenizing the text may include breaking down the sentences of the text into smaller units, such as words or subwords (e.g., tokens). Tokenizing the text may allow the NLP model 200 to analyze text at a granular level by identifying linguistic patterns and relationships between tokens. For example, a sentence or sentence fragment such as “The patient underwent surgery” may be broken down into individual tokens, e.g., [“The,” “patient,” “underwent,” “surgery”].

Moreover, the tokenization process in the input layer 210 may tokenize complex languages or domain-specific jargon. For example, in medical documents, terms such as “nephrectomy” may be treated as a single token, while in financial documents, numbers, currencies, or abbreviations such as “Q4” or “EBITDA” may be treated as distinct tokens. Moreover, the input layer 210 may handle different tokenization schemes depending on the language or type of text. The input layer 210 may employ subword tokenization methods, such as Byte-Pair Encoding (BPE), which may break down rare or compound words into more manageable subwords. The NLP model 200 may handle unknown words by breaking them into smaller, recognizable parts. For instance, a complex word like “antidisestablishmentarianism” may be split into subwords: [“anti,” “dis,” “establish,” “ment,” “arian,” “ism”]. By employing one or more tokenization approaches, the NLP model 200 may process a wide variety of text inputs, even those containing rare or novel terms. Once the text has been tokenized, the input layer 210 may pass the tokens to one or more other layers of the NLP model 200 for further processing.

According to some aspects, the input layer 210 may perform one or more preprocessing steps, such as normalizing the text. For example, normalizing the text may include converting all characters to lowercase, removing punctuation or special characters, and/or handling common linguistic variations (e.g., stemming or lemmatization). For example, in a legal document, “Contracts” and “contract” may be reduced to a base form “contract” to ensure uniformity in analysis. The input layer 210 may also deal with issues such as sentence segmentation, ensuring that the text is split into appropriate sentence boundaries. By ensuring that the raw text is properly prepared for deeper semantic analysis, the input layer 210 may allow the NLP Model 200 to surface relevant information from large datasets and electronic documents.

The embedding layer 220 of the NLP Model 200 may transform the tokenized words from the input layer 210 into a numerical format that captures the semantic meaning of the text. This embedding layer 220 may map each token into a high-dimensional vector space, where words with similar meanings or contexts may be positioned closer together. Thereby, the embedding layer 220 may represent words as vectors that encode linguistic and semantic information. For example, in a legal document dataset, words such as “contract” and “agreement” may be placed near each other in the vector space due to their close semantic relationship, while unrelated words such as “contract” and “banana” may be farther apart.

The vector representations may be created through one or more embedding techniques (e.g., Word2Vec, GloVe, etc.) or may be generated by transformer models (e.g., BERT). For example, words may be represented by fixed-length vectors based on the contexts in which they appear during training. In a sentence such as “The lawyer reviewed the contract,” the embedding layer 220 may learn that “lawyer” and “contract” frequently appear in related contexts, thus positioning their vector representations close together. Contextual embeddings generated by transformer models may take into account the entire sentence's context, meaning that the word “contract” in “The lawyer reviewed the contract” may have a different vector representation than “contract” in “The muscle contracts quickly.” This context-aware representation may allow the NLP model 200 to better understand and process polysemous words, which may have different meanings depending on the context.

According to some aspects, the NLP model may capture syntactic information as well as semantic relationships. By encoding both the meaning and the grammatical role of each word, the embeddings may allow the NLP Model 200 to understand individual words and also understand how the individual words function together in a sentence. For instance, in the sentence “The company terminated the contract,” the embedding layer 220 may capture the relationships between “company,” “terminated,” and “contract” in such a way that the NLP model 200 understands that the company is the actor and the contract is the object being acted upon. This capability may be particularly important in domain-specific applications, such as legal or financial document analysis, where the precise meaning of terms may depend heavily on their syntactic roles and relationships within the text.

The transformer layer 230 of the NLP Model 200 may allow the NLP model 200 to understand complex relationships between words in a sentence by processing the entire input text simultaneously. For example, the transformer layer 230 may include one or more transformer architectures, such as BERT (Bidirectional Encoder Representations from Transformers) and GPT (Generative Pre-trained Transformer). The transformer architectures may capture local and/or global dependencies within the text. The transformers may use a parallelized approach to process all words in a sentence at once and avoid the limitations of sequence-based models, such as difficulty in capturing long-range dependencies. For example, in a legal document, the transformer layer 230 may recognize that the word “attorney” in the first part of a sentence is closely related to “lawsuit” mentioned later, even if they are separated by multiple intervening words.

According to some aspects, the transformer layer 230 may use self-attention to weigh the importance of different words in relation to each other. For example, in a sentence such as “The contract was signed by the attorney after the negotiation concluded,” the transformer layer 230 may identify that “contract” and “signed” are semantically linked, even though they are not adjacent in the sentence. Attention scores may be computed for each word in the sentence relative to every other word, e.g., determining how much each word should “attend” to others in order to capture their relevance. The attention scores may be generated through mathematical operations involving query, key, and value vectors for each word, allowing the NLP model 200 to focus on the most contextually significant parts of the sentence. The self-attention may enable the NLP Model 200 to surface nuanced relationships and patterns in complex texts, such as legal agreements or regulatory documents.

According to some aspects, the transformer layer 230 may include multiple stacked layers of self-attention mechanisms (e.g., multi-head attention layers), which may allow the NLP model to look at the text from different perspectives simultaneously. Each attention head may focus on different relationships within the text, allowing the NLP model to capture a wide range of linguistic features, e.g., from grammatical structure to higher-level semantic meaning. For example, in a financial document, one attention head may focus on numerical values like “revenue” and “profits,” while another attention head may concentrate on legal terms such as “contract” and “liability.” By integrating insights from multiple attention heads, the transformer layer 230 may create a rich, multi-faceted understanding of the text. This deep contextual understanding may be critical when surfacing relevant information from large electronic datasets, allowing the NLP Model 200 to handle complex, domain-specific queries with high accuracy and relevance.

The output layer 240 of the NLP Model 200 may generate a structured representation of the text's semantic meaning. According to some aspects, the output layer 240 may transform the learned embeddings and attention-based representations into a format suitable for a target task, such as document classification, summarization, and/or question answering. The output layer may apply a final set of operations, such as dense layers or activation functions, to map high-dimensional vectors produced by the preceding layers of the NLP model 200 into the desired output format. For instance, if the task is document classification, the output layer 240 may generate a probability distribution over predefined categories (e.g., legal, medical, or financial). In the case of text summarization, the output layer 240 may generate a condensed version of the input text, e.g., highlighting key sections or clauses. Moreover, one or more parameters of the output layer may be fine-tuned during training to ensure accurate and meaningful outputs based on the learned patterns.

For example, in the context of processing legal contracts, the output layer 240 may identify and highlight important clauses such as “termination conditions” or “liability limitations.” After the attention and transformer layers capture the relationships and dependencies between legal terms, the output layer may synthesize the information to produce a summary or classification. The output may include a list of key provisions, along with their relevant semantic information, which may be surfaced to a user reviewing the contract. In a question-answering task, the output layer 240 may return specific clauses or sections that directly answer a query, such as, “What are the termination conditions in this contract?” By leveraging the semantic understanding generated by the other layers of the NLP model 200, the output layer 240 may ensure that the NLP Model 200 provides relevant and contextually appropriate results.

According to some aspects, the output layer 240 may include one or more fully connected layers followed by an activation function such as softmax (e.g., for classification tasks) or linear functions (e.g., for regression-based tasks). The embeddings and attention scores generated by the NLP model 200 may be fed into the fully connected layers, where weights are applied to convert the semantic representations into output scores or categories. For instance, in document summarization, the output layer 240 may generate a vector that represents the most important sections of a document, with each value in the vector corresponding to the relevance of a specific section or sentence. The output may be post-processed to generate a human-readable summary or to structure the information for further downstream applications, such as populating fields in a regulatory form or surfacing relevant paragraphs in a search result. Thereby, the NLP Model 200 may be adapted to various text analysis tasks, providing a robust solution for surfacing relevant information from electronic documents.

FIG. 3 illustrates a schematic representation of a dataset 300. The dataset 300 may be used to train the NLP model 200. The dataset 300 may include domain-specific text data, which may provide foundational material for the NLP Model 200 to learn and recognize complex linguistic patterns and terminologies pertinent to a given domain. The dataset 300 may include one or more of a general corpus 310, a domain-specific corpus 320, and/or labeled data 330.

The general corpus 310 may be 300 used to train the NLP Model 200. The general corpus 310 may include a wide array of text data from diverse sources, such as one or more of online articles, encyclopedias, blogs, and news archives. Moreover, the general corpus 310 may provide a broad linguistic foundation for the NLP Model 200, providing the NLP Model 200 with a well-rounded understanding of general language usage. By including the vast and varied nature of the general corpus 310, the NLP Model 200 may recognize and process different writing styles, grammatical structures, and sentence patterns that occur across various forms of communication. For example, the general corpus 310 may contain text data representing different narrative forms, such as descriptive writing, instructional text, or conversational dialogues, enabling the NLP Model 200 to adapt to a range of textual scenarios.

According to some aspects, inclusion of the general corpus 310 in the training process may provide the NLP Model 200 with an ability to generalize linguistic rules, such as subject-verb agreement, pronoun reference, and syntactical structure. By exposing the NLP model 200 to a large and diverse general corpus 310, the NLP Model 200 may learn to manage and process standard grammatical constructs, which may be applied to domain-specific contexts later in the training process. For example, the NLP model 200 may first learn from the general corpus how conjunctions like “and” or “but” are used to connect clauses, or how passive voice differs from active voice. The NLP model 200 may rely on the training and associated base-level understanding of language mechanics to interpret meaning accurately and efficiently. Moreover, the NLP model 200 may use the base-level understanding of language mechanics to interpret meaning accurately and efficiently when the model encounters more complex or domain-specific text.

Furthermore, the general corpus 310 may support the NLP Model 200 in handling variations in language, such as synonym usage, different forms of expressions, and regional dialects. For example, the NLP model 200 may learn to recognize that “automobile” and “car” are interchangeable in many contexts, or that British English spellings (e.g., “colour”) differ from American English spellings (e.g., “color”). Exposure to these variations may enable the NLP model 200 to apply learned rules across different forms of unstructured data. By building broad linguistic competence through the general corpus 310, the NLP Model 200 may be better equipped to handle more complex and specialized text in the domain-specific corpus 320, ultimately improving performance of the NLP model 200 in surfacing semantically relevant information from large and diverse datasets.

The domain-specific corpus 320 may be used to train the NLP Model 200 on text data unique to a particular industry or sector. The domain-specific corpus 320 may provide the NLP model 200 with specialized understanding by exposing it to text data from specific fields such as legal, medical, or financial sectors. The domain-specific corpus 320 may contain text types that are frequently encountered in the chosen domain, such as legal contracts, medical research articles, or financial statements. By training on the domain-specific corpus 320, the NLP Model 200 may become adept at interpreting and processing domain-specific terminologies, complex sentence structures, and/or contextual nuances that define the language of the industry. For instance, in the legal domain, the NLP model 200 may learn to recognize phrases like “force majeure” or “indemnification,” which may have specialized meanings that differ significantly from their use in everyday language.

The domain-specific corpus 320 may be used to train the NLP Model 200 to understand the relationships between key terms within the context of the domain. For example, in the medical field, the model may learn to recognize associations between terms such as “diagnosis,” “treatment plan,” and “prognosis,” understanding how these terms relate to each other in patient reports or medical literature. Similarly, in the financial domain, the NLP model 200 may learn nuanced differences between terms such as “revenue,” “net income,” and “profit,” recognizing how these terms are used in different sections of financial reports. This targeted exposure may allow the NLP model 200 to surface relevant information with a higher degree of precision, as it can accurately interpret, and extract content based on the specific patterns, structures, and terminologies of the domain.

In addition to improving accuracy, the domain-specific corpus 320 may further enhances the ability of the NLP model 200 to provide context-aware responses and insights. For example, in legal documents, terms such as “breach of contract” or “termination clause” may appear in varying contexts, each with its own legal implications. The domain-specific corpus 320 may allow the NLP Model 200 to recognize the contextual significance of these terms, helping the NLP model 200 to surface the most relevant sections of a contract or legal case. This specialized training may improve the performance of the NLP model 200 in real-world applications, where understanding intricate relationships between domain-specific terms and their context within documents may be important. Through the focused domain-specific corpus 320, the NLP Model 200 may become a powerful tool for industries that rely heavily on precise and contextually relevant information retrieval from complex and large datasets.

The labeled data 330 may be used to train the NLP Model 200. The labeled data 330 may include text data that has been annotated with specific labels, enabling the NLP Model 200 to perform supervised learning tasks such as classification, entity recognition, and key information extraction. Labels within the labeled data 330 may correspond to domain-specific concepts, entities, or relationships that are critical for the ability of the NLP model 200 to surface relevant information accurately. For example, in the context of legal documents, labeled data may highlight specific clauses such as “termination conditions,” “liability limitations,” or “force majeure,” guiding the NLP model 200 to recognize and classify similar clauses across various contracts. This training process may allow the NLP model 200 to learn how to associate terms with predefined categories, improving its ability to categorize and retrieve information with high precision.

The labeled data 330 may enhance the capacity of the NLP model 200 to generalize from domain-specific knowledge by providing explicit examples of patterns or structures within the text. For instance, in a medical domain, data may be labeled with medical entities like “diagnosis,” “medication,” or “treatment plan.” This labeled information may allow the NLP Model 200 to understand not only the vocabulary but also the context in which the entities appear, allowing the NLP model 200 to identify similar terms and relationships in unseen medical documents. The labeled data may provide the NLP model 200 with a detailed understanding of the domain's structure, making the NLP model 200 capable of recognizing key information even when it is phrased differently or presented in varying contexts. This capability may be crucial in industries like law or healthcare, where the correct identification of terms and clauses may significantly impact decision-making and operational efficiency.

Moreover, the labeled data 330 may support fine-tuning of the NLP Model 200 through supervised learning algorithms. The NLP model 200 may learn to minimize error by adjusting its internal parameters based on labeled examples. For instance, during the training phase, if the NLP model 200 misclassifies a clause labeled as “termination condition” as something else, the error may be propagated back through the network, allowing the NLP model 200 to update its parameters to improve future predictions. This iterative process may enable the model 200 to refine its understanding of domain-specific language patterns and relationships. In practical applications, the labeled data 330 may provide the NLP Model 200 with the ability to reliably extract critical information, such as pinpointing specific clauses in legal documents or identifying patient treatment details in medical records, ultimately improving the efficiency and accuracy of information retrieval across large datasets.

FIG. 4 illustrates a schematic representation of an electronic document 400, which may be processed by the NLP Model 200 to surface relevant information. The electronic document 400 may contain multiple types of text data, each of which may be labeled with numbered components that correspond to different sections or types of information within the electronic document 400. For example, the electronic document 400 may include a title section 410, which may represent a primary heading or title of the electronic document 400 and may provide a high-level summary of the content. Additionally, the electronic document 400 may include a body section 420, which may contain the bulk of the textual content and may encompass various subsections, paragraphs, and sentences. This body section 420 may include domain-specific terminologies or key phrases that may be interpreted by the NLP Model 200. The electronic document 400 may further include metadata 430, such as authorship information, timestamps, or version control data, which are stored in structured formats that aid in organizing the document within a larger dataset.

The NLP Model 200 may apply one or more machine learning models to analyze each component of the electronic document 400. For instance, the NLP Model 200 may tokenize the text within the body section 420, breaking it down into smaller units such as words or subwords, which may then be mapped into high-dimensional vector embeddings. The embeddings may represent the semantic meaning of the text, allowing the NLP Model 200 to recognize patterns, relationships, and contextual nuances. The NLP model 200 may be particularly effective in identifying domain-specific terminology in the body section 420, such as legal clauses, medical terms, or financial jargon, depending on the context in which the electronic document 400 is used. Moreover, the title section 410 and/or the metadata 430 may also be processed by the NLP Model 200 to extract relevant information, such as determining the topic or purpose of the document based on the title or identifying authorship trends based on metadata.

The NLP model 200 may interact with each component of the electronic document 400 to enhance usability of the electronic document 400 within a larger information retrieval system. The title section 410 may provide initial context or clues about the subject matter of the electronic document 400, which may help the NLP model 200 focus its analysis when processing the body section 420. The body section 420 (e.g., containing the main text) may serve as the primary source of content for the NLP Model 200 to generate embeddings and surface relevant information. The metadata 430 may provide auxiliary information for the NLP model 200 to correctly categorize, retrieve, and version-control the electronic document 400. The NLP Model 200 may improve the efficiency of document management, providing quick and accurate retrieval of key information from vast collections of electronic documents. For example, in a legal document, the NLP Model 200 may extract and highlight specific clauses like “termination conditions” or “force majeure” from the body section 420 based on the semantic analysis, significantly streamlining tasks such as contract review.

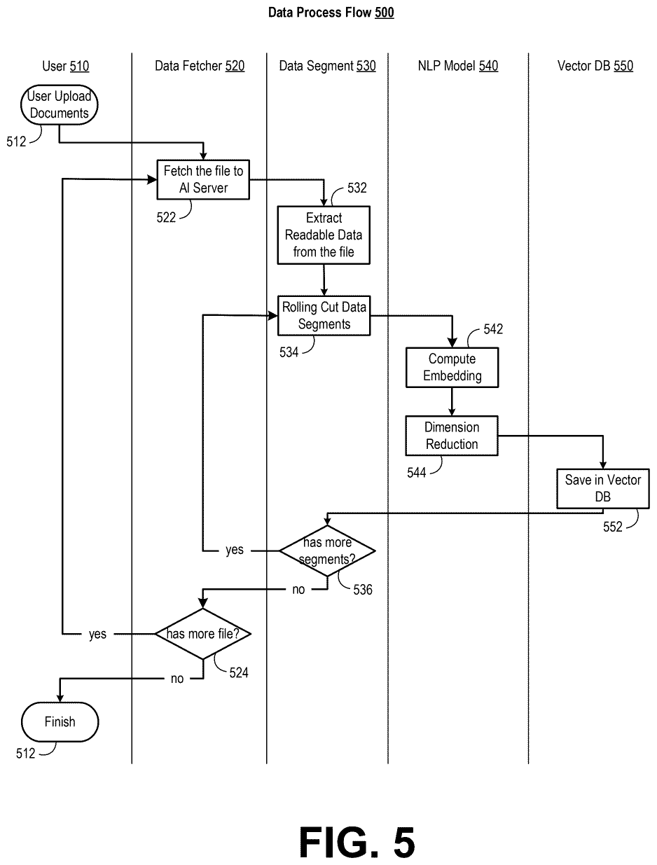

The data process flow 500 illustrated in FIG. 5 may provide a systematic sequence of operations implemented by the document management system 102 for managing, processing, and retrieving electronic documents. The data process flow 500 may begin with the user process 510 at step 512, where a user may upload the electronic documents 115. The electronic documents 115 may include a variety of formats such as DOC, PDF, HTML, and scanned images, which may be processed by the document management system 102. The electronic documents 115 may originate from different sources, such as regulatory filings, legal contracts, medical records, or financial documents, depending on the industry and specific use case.

Uploading the electronic documents 115 may begin with a user interacting with the document management system 102 via a user interface provided by the UI module 120. The user may access the user interface on a computing device 104, such as a desktop computer, tablet, or smartphone, connected to the network 106. The UI module 120 may offer an intuitive platform for users to select and upload the electronic documents 115, either by dragging and dropping files into the interface, browsing the file system, or connecting to external sources, such as cloud storage platforms or one or more integrated document management systems.

Once selected, the electronic documents 115 may be uploaded to the document management system 102 through a secure transfer protocol, ensuring that the files are transmitted without data loss or corruption. The document management system 102 may support batch uploads, allowing users to upload multiple files simultaneously. During the upload, metadata associated with the electronic files 115, such as the document title, author, and date of creation, may also be captured to aid in subsequent indexing and retrieval processes.

At step 522, the data fetcher process 520 may retrieve the uploaded files and forward them to an AI server for further processing, operating as an intermediary to efficiently and securely transfer the uploaded files from the storage location to the AI server. The data fetcher process 520 may be initiated by the uploading of the documents and may include accessing the storage location where the documents are temporarily held. The storage location may be on a local server, a distributed database, or cloud storage, depending on the system architecture and where the files were initially uploaded at step 512. The data fetcher process 520 may forward the electronic documents to the AI server over a secure network connection. The transfer may involve encryption protocols to protect sensitive information during transit, ensuring compliance with data security standards. The data fetcher process 520 may also include error-checking mechanisms to verify that the documents have been successfully transferred and are ready for processing, thereby maintaining the integrity of the data process flow 500.

The AI server, which may operate within a distributed system, may then initiate the data segment process 530 at step 532. The AI server may use advanced AI models to extract readable data from the uploaded files, transforming the raw content into structured segments that can be further processed. The data segment process 530 may include the AI server using Optical Character Recognition (OCR) models if the electronic documents contain scanned images or non-text formats. The OCR models may convert the image-based text into machine-readable text, ensuring that the content is accessible for subsequent processing. Once the text is extracted, the AI server may utilize NLP models to analyze the text's structure and semantics. The NLP models may include pre-trained models such as BERT (Bidirectional Encoder Representations from Transformers) or GPT (Generative Pre-trained Transformer), one or more of which may be used to understand context, extract relevant information, and/or identify key components of the text.

The AI server may segment the extracted data into meaningful units or “content slices” based on the semantic information derived by the NLP models. The segmentation may involve breaking down the text into paragraphs, sentences, or other logical units, depending on the document's content and structure. The AI models may be trained to recognize patterns and contextual cues within the text, ensuring that each segment maintains its semantic integrity. For example, in a legal document, the AI models may segment the text into sections such as “Introduction,” “Facts,” “Analysis,” and “Conclusion,” ensuring that each segment reflects a coherent piece of the document's overall structure.

Once the readable data is extracted, the data segment process 530 may determine rolling cut data segments (e.g., “content slices”) at step 542. Determining rolling cut data segments may comprise dividing the text into overlapping content slices to preserve contextual integrity. A sliding window method may be used to keep important semantic content from being lost between segments. The data segments may be used to maintain the coherence of the extracted information. For example, if a text segment includes a complex sentence or a multi-sentence idea, cutting the text at a fixed point could result in fragmented content that loses its meaning or context. By using a sliding window approach, where the window size may, for example, be set to capture 500 words with a 50-word overlap, each content slice may contain sufficient contextual information from the preceding and succeeding portions of the text. The document management system 102 may maintain the coherence of the extracted information, making each segment more semantically complete and meaningful when processed further, such as during the generation of high-dimensional embeddings or when matching content slices to specific sections of an eSTAR form. The overlapping segments may also allow the document management system 102 to perform more accurate and contextually aware searches, as it minimizes the risk of critical information being isolated or misinterpreted due to segmentation.

Following segmentation, the data process flow 500 may advance to step 542, where the NLP model 540 may compute embeddings for each content slice. The embeddings may be high-dimensional vectors designed to encapsulate the semantic essence of the content. The process of computing embeddings may include the NLP model analyzing the text within each content slice to understand its contextual meaning, syntactic structure, and/or the relationships between words and phrases. The NLP model 540, which may be pre-trained on extensive datasets, may apply transform the textual information into numerical representations that exist within a multi-dimensional space.

Each embedding may serve as a unique fingerprint of the content slice, with dimensions that encode various aspects of the text, such as the importance of certain terms, the presence of domain-specific language, and the overall context in which the information is presented. For instance, a content slice discussing “data privacy regulations” may include an embedding that positions it close to other slices related to legal compliance or cybersecurity in the high-dimensional space. This proximity in the vector space may allow for efficient similarity comparisons, making it easier for the document management system 102 to retrieve relevant content when a query is made. The embeddings may enable the document management system 102 to bypass traditional keyword-based searches, instead leveraging the deep, context-aware understanding of the text to deliver highly accurate and relevant results. Moreover, the document management system 102 may enhance search and retrieval efficiency, handling large volumes of data while maintaining a high level of precision in matching content to queries or specific sections of the eSTAR form.

At step 544, the NLP model 540 may undertake the process of dimension reduction on the high-dimensional embeddings to optimize both storage and retrieval efficiency within the vector database. Each embedding, originally represented as a vector in a multi-dimensional space, may contain hundreds or even thousands of dimensions, encapsulating intricate details about the semantic content of the text. While these detailed embeddings may facilitate capturing the nuanced meaning of the text, the detailed embeddings may also lead to significant storage requirements and computational overhead during retrieval processes.

To address these challenges, the NLP model 540 may apply one or more advanced dimension reduction techniques such as Principal Component Analysis (PCA), t-Distributed Stochastic Neighbor Embedding (t-SNE), or autoencoders. The number of dimensions in the embeddings may be reduced while preserving as much of the original semantic information as possible. By identifying and retaining the most critical features that contribute to the overall meaning of the text, dimension reduction may compress the embeddings into a lower-dimensional space that is more manageable and efficient for storage.

This reduction in dimensionality may decrease the storage footprint of each embedding within the vector database and/or accelerate the retrieval process. When a search query is made, the reduced-dimensional embeddings may allow for faster similarity calculations, enabling the system to quickly locate and return relevant content slices. Moreover, dimension reduction may mitigate the risk of overfitting, where overly complex models might capture noise rather than meaningful patterns in the data. By focusing on the most significant dimensions, the data process flow 500 may maintain high accuracy in matching content slices to queries, while also ensuring that the document management process remains scalable and efficient even as the volume of data grows.

At step 552, the data process flow 500 may save the output from step 544 (e.g., the dimensionally reduced embeddings) into the vector database 550. The vector database 550 may efficiently manage and store the high-dimensional embeddings, ensuring that they can be quickly retrieved and accurately matched against future search queries. The structure of the vector database 550 may be optimized for handling vast quantities of complex, high-dimensional data, which may maintain the performance and scalability of the document management system 102 as it processes increasing volumes of information.

The vector database 550 may utilize advanced indexing techniques, such as approximate nearest neighbor (ANN) search algorithms, to facilitate rapid and precise retrieval of embeddings based on their semantic similarity. The search algorithms may be used to perform efficient similarity searches, where the document management system 102 may need to quickly compare the query embeddings with the stored embeddings to identify the most relevant content slices. By organizing the embeddings in a way that preserves their semantic relationships, the vector database 550 may enable the system to deliver fast and contextually accurate search results, even when dealing with large datasets.

Moreover, the vector database 550 may incorporate robust encryption mechanisms to safeguard the stored embeddings and associated content slices. Given the sensitive nature of the data that might be processed, such as legal documents, medical records, or financial information, ensuring data security may be particularly important. The encryption mechanisms may ensure that the embeddings are protected from unauthorized access, both at rest and during transmission. This layer of security may comply with data protection regulations and for may maintain the trust of users who rely on the document management system 102 to handle confidential and sensitive information.

After storing the embeddings, the data segment process 530 may determine at step 536 whether there are more segments to process. If more segments are identified, the data process flow 500 may return to step 534 to extract and process the additional segments. If no further segments are present, the data fetcher process 520 at step 524 may check for additional files to process. If more files are available, the data process flow may return to step 522; otherwise, the user process 510 may conclude at step 512, marking the end of the data process flow 500.

This data process flow 500 may highlight the ability of the document management system 102 to handle complex data structures, efficiently segment and process documents, and securely store and retrieve information, as further detailed in the disclosure. Through innovative use of NLP models, high-dimensional embeddings, and/or vector databases, the document management system 102 may ensure that documents are managed in a manner that overcomes the limitations of traditional folder-based and tag-based management systems, offering a more advanced solution for document retrieval and management.

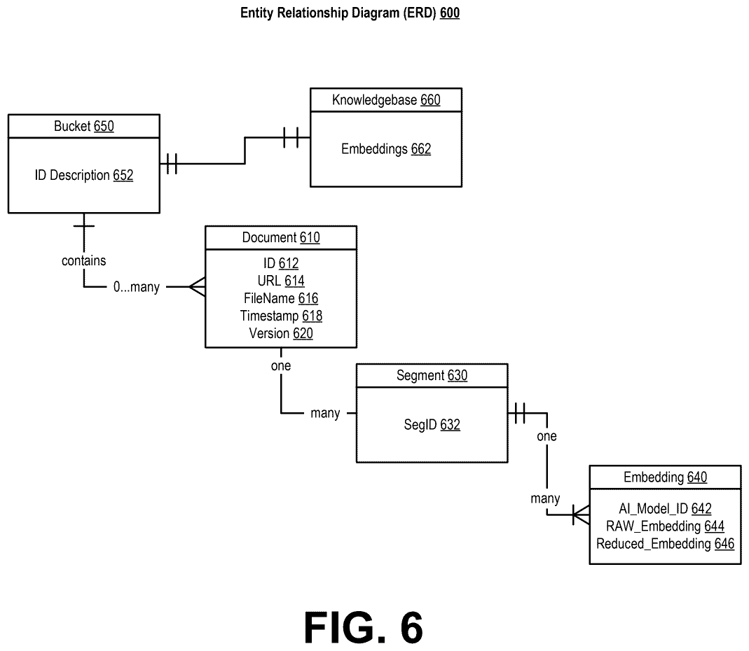

As illustrated in FIG. 6, the entity relationship diagram 600 illustrates an example of an overview of the relationships between various components within the document management system 102. Moreover, the entity relationship diagram 600 may illustrate how the document management system 102 organizes and processes electronic documents by breaking them down into segments, generating embeddings, and organizing them within buckets and knowledgebases. According to some aspects, the document management system 102 may facilitate efficient document management and retrieval while handling complex data structures with high accuracy and relevance to provide a robust solution for environments where precise document processing is essential.

The entity relationship diagram 600 may include several entities, e.g., a document 610, a segment 630, an embedding 640, a bucket 650, and/or a knowledgebase 660, each of which may play a role in managing and processing electronic documents.

The document 610 may represent one or more uploaded electronic files within the document management system 102. Each document 610 may include several attributes, such as an identifier attribute 612, a URL attribute 614, a filename attribute 616, a timestamp attribute 618, and a version attribute 620. The identifier attribute 612 may uniquely identify the document 610 within the document management system 102. The URL attribute 614 may store a link to the location of the actual file, allowing the document management system 102 to reference the document 610, e.g., without storing an entire file associated with the document 610 within the database 110. Referencing the document 610 using the URL attribute 614 may reduce storage overhead and facilitate easier access to the document 610. The filename attribute 616 may provide a label for the document 610, while the timestamp attribute 618 may record a date or time associated with the creation or last modification of the document 610 (e.g., facilitating version control and tracking document history). The version attribute 620 may support version control by allowing the document management system 102 to manage different iterations of the same document and ensuring that users may access the most current or relevant version as needed.

The segment 630 may represent one or more logical divisions or “content slices” within the document 610, e.g., created during the data segmentation process. Each segment 630 may be associated with a segment identifier 632, which may uniquely identify the segment 630 within the document 610. The segmentation may allow the document management system 102 to break down complex documents into manageable and contextually coherent units, which may then be processed and retrieved. The one-to-many relationship between the document 610 and the segment 630 may indicate that a single document 610 may be divided into multiple segments 630, each capturing a specific portion of the content of the document 610.

The embedding 640 may represent high-dimensional vectors computed for each segment 630 and encapsulating a semantic essence of the text. The embeddings 640 may enable advanced search and retrieval functionalities within the document management system 102. Each embedding 640 may include an AI model identifier 642, indicating which AI model (e.g., NLP models such as BERT or GPT) was used to generate the embedding 640. The raw embedding 644 may comprise the initial high-dimensional vector generated by the AI model, while the reduced embedding 646 may comprise a dimensionally reduced version of the raw embedding (e.g., optimized for storage and retrieval efficiency within the database 110). The one-to-many relationship between the segment 630 and the embedding 640 may illustrate that each segment 630 may be processed by multiple AI models, resulting in different embeddings that capture various semantic perspectives.

The bucket 650 may group related documents together, serving as a container for managing and organizing documents within the document management system 102. The bucket 650 may include an identifier description 652 to describe the purpose or characteristics of the bucket. This organizational structure may utilize efficient categorization and retrieval of documents based on specific criteria or use cases. The bucket 650 may have a one-to-many relationship with the document 610, indicating that a single bucket 650 may contain multiple documents 610. For example, documents may be grouped based on common themes, projects, or regulatory requirements.

The knowledgebase 660 may represent a collection of embeddings 662, which may be stored and managed as part of the knowledge repository of the document management system 102. The one-to-one relationship between the bucket 650 and the knowledgebase 660 may illustrate that each bucket is associated with a dedicated knowledgebase 660, which may store the embeddings 640 generated from the documents 610 within that bucket. This relationship may allow the document management system 102 to build a specialized knowledge repository for each group of documents, enabling more accurate and context-aware retrieval of information when users perform searches or queries.

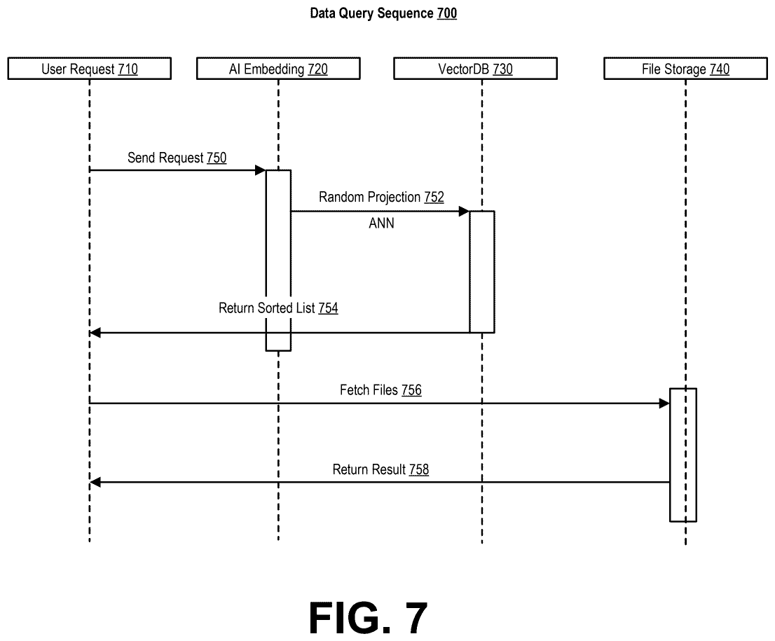

As illustrated in FIG. 7, a data query sequence 700 may include a series of interactions between various components of the document management system 102. According to some aspects, the data query sequence may utilize advanced AI techniques to ensure that the most relevant information is retrieved efficiently and accurately in response to a query. Moreover, the document management system 102 may handle various file formats, perform semantic slicing, and optimize search through embedding-based methods. Accordingly, the data query sequence 700 may represent a significant improvement over traditional document management systems, including automating document management and form completion, and may provide precise and rapid information retrieval for regulatory environments.

The data query sequence 700 may commence when a user request 710 is initiated. This user request 710 may originate from a user interacting with a user interface (UI) of the document management system 102, where the user may seek to retrieve specific information or documents stored within the document management system 102. The request may include a query for relevant content based on criteria, such as keywords, topics, or complex natural language queries encapsulating a more nuanced intent.

At step 750, the user request 710 may be transmitted to the AI embedding 720. The AI embedding 720 may transform the raw input from the user into a format that can be efficiently processed by the document management system 102. For example, the AI embedding 720 may generate a high-dimensional representation of the request. The high-dimensional representation may comprise a mathematical vector that encapsulates the semantic meaning of the query, allowing the system to perform sophisticated searches.

The AI embedding 720 may leverage a pre-trained NLP model to generate this high-dimensional representation. The NLP model may include one or more algorithms such as BERT (Bidirectional Encoder Representations from Transformers), GPT (Generative Pre-trained Transformer), or similar architectures. The NLP models may be used to understand and encode the complexities of human language. The NLP model may process the textual input of the query by tokenizing the text, analyzing its syntactic structure, and extracting semantic relationships between words and phrases. Through this process, the NLP model may convert the user's input into an embedding, e.g., a dense vector in a multi-dimensional space where semantically similar inputs are located closer together.

The high-dimensional embedding may allow the document management system 102 to perform context-aware searches within the vector database 730. By converting the user's query into a rich, multi-dimensional format, the document management system 102 may match the query against stored document embeddings with a high degree of accuracy, e.g., retrieving content that is contextually relevant. The precision and relevance of the search results may be enhanced accordingly, making the document management system 102 more effective at handling complex and varied queries.

At step 752, the AI embedding 720 may execute a random projection process to transform the high-dimensional query generated from the user request into a format that is more manageable and suitable for efficient comparison within a vector database 730. The transformation process may optimize the search operations within the document management system, particularly when dealing with large-scale datasets that contain vast amounts of high-dimensional data.

The concept of random projection may include mapping the high-dimensional data into a lower-dimensional space in a way that approximately preserves the distances between points. Mapping the high-dimensional data may be based on the Johnson-Lindenstrauss lemma, which may embed a set of points in high-dimensional space into a lower-dimensional space such that the distances between the points are nearly preserved. The random projection may reduce the dimensionality of the query embedding while retaining the semantic relationships between the elements of the query. This reduced-dimensional representation may be used by the document management system 102 to perform rapid and efficient searches.

Moreover, the AI embedding 720 may apply one or more Approximate Nearest Neighbor (ANN) algorithms. The ANN algorithms may quickly find points in a dataset that are closest to a given query point, even in high-dimensional spaces. The ANN algorithms may strike a balance between computational expense and efficiency by finding an approximate nearest neighbor. By applying the ANN algorithms, the AI embedding 720 may transform the high-dimensional query into a lower-dimensional space where the nearest neighbors (i.e., the most relevant content slices or document segments in the vector database) may be identified more efficiently. This transformation may reduce the computational complexity of the search process, allowing the document management system 102 to handle large datasets without compromising on performance.

Moreover, the use of random projection combined with ANN algorithms may ensure that the search process remains scalable as the volume of data grows. As more documents and content slices are added to the vector database 730, the document management system 102 may continue to perform searches efficiently without a linear increase in computational load. This capability may be significant in enterprise environments where the document management system must handle a continuous influx of new data while still providing fast and accurate search results.

The vector database 730 may serve as the repository for the content slices and their associated high-dimensional embeddings. The embeddings may include numerical representations that encapsulate the semantic content of the document segments. At step 754, once the AI embedding 720 has performed the necessary transformations on the user query and generated a corresponding query embedding, the vector database 730 may process the query. The vector database may manage and store large volumes of high-dimensional data, including the content slices (e.g., segments of the original documents) and their associated embeddings. Storage of the embeddings may preserve their spatial relationships in a multi-dimensional space, ensuring that semantically similar content slices are positioned close to each other.

The query processing step may include the vector database 730 comparing the query embedding, which may represent the semantic essence of the user request, with the stored embeddings of the content slices. The comparison may be executed using similarity search algorithms, such as Approximate Nearest Neighbor (ANN) algorithms, which may efficiently locate the most relevant data points in high-dimensional spaces by identifying which of the stored content slices most closely match the semantic intent of the user query.

Once the vector database 730 has completed the comparison, it may generate a sorted list of relevant content slices. This list may be organized based on the degree of semantic similarity between the query embedding and the stored embeddings. The content slices that are determined to be the closest matches to the user query may be ranked higher in the list. The ranking may be determined by calculating the distance between the query embedding and each stored embedding in the vector space, e.g., the smaller the distance, the higher the relevance of that content slice.

This sorted list may represent a best approximation of the most relevant content slices in response to the request. The semantic similarity that may form the basis of the sorting may be used to retrieve content that is contextually appropriate and aligned with the intent of the user. Unlike traditional keyword-based search methods, which may return results that match specific terms but not the broader context, the use of the embeddings may allow the vector database 730 to account for the nuances of natural language, including synonyms, related concepts, and contextual meanings.

For example, if the user query relates to “intellectual property laws,” the vector database 730 may return content slices that not only mention “intellectual property” explicitly but also those that discuss related legal concepts, such as patents, trademarks, and copyright, even if those exact terms were not used in the query. This capability may be enabled by the high-dimensional embeddings, which may capture deeper semantic relationships between different pieces of text.

Additionally, the sorted list generated by the vector database 730 may include metadata associated with each content slice, such as the original location within the document, timestamps, and confidence scores indicating the relevance of each slice to the query. The metadata may be used by the document management system 102 to further refine the results presented to the user, offering a more tailored and precise response to their query.

At step 756 in the data query sequence 700, the user request 710 may initiate retrieval of one or more relevant files from the file storage 740. The file storage 740 (e.g., a distributed database or a cloud-based storage system) may serve as the repository for the original electronic files and their corresponding segmented content slices. The storage system may be robust, scalable, and secure and may handle large volumes of data, support multiple simultaneous access requests, and ensure data redundancy and security.

Retrieving files from the file storage 740 may begin once the user request 710 receives the sorted list of relevant content slices from the vector database 730. The sorted list may represent the content that is most semantically aligned with the query. To provide the user with the complete and original context, the document management system 102 may fetch the full files from which the relevant content slices were extracted.

The file storage 740 may store the electronic files in a manner that supports efficient retrieval. For example, the files may be indexed based on various attributes such as file type, creation date, associated metadata, and/or references to the segmented content slices. The storage system may also support version control, ensuring that users can access the most recent or historically relevant versions of the files as needed.

The user request 710 may initiate the retrieval process by referencing the identifiers or metadata associated with the relevant content slices. The identifiers may help the file storage 740 locate the exact files or portions of files that need to be retrieved. The storage system may utilize advanced indexing techniques to quickly locate the files, even within a distributed or cloud-based environment where data is spread across multiple servers or geographic locations.

Once the relevant files are located, the file storage 740 may fetch the files. For example, the segmented content slices may be assembled back into their original format or context, e.g., if the user request 710 requires the entire document rather than just the extracted slices. The storage system may include any associated metadata (e.g., annotations, timestamps, and/or version history) with the retrieved files.

At step 758, the file storage 740 may return the fetched files to the user request 710. This marks the completion of the data query sequence 700. The returned files are then made available to the user, either through a user interface or directly within the application that issued the query. Depending on the system's configuration, the user may receive the files in their entirety, or they may be presented with a summary or preview of the relevant content, with options to access the full documents as needed.

The architecture of the file storage 740 (e.g., distributed or cloud-based) may support high availability and quick access to data. In a distributed database, the files may be stored across multiple nodes, allowing for load balancing and fault tolerance. For example, in a cloud-based system, the storage may leverage the elasticity of cloud infrastructure to scale according to demand, providing rapid retrieval times even under heavy load conditions. Moreover, the file storage 740 may include security features such as encryption, access controls, and/or audit logs to ensure that the retrieval of files is both secure and compliant with relevant data protection regulations. For example, the security features may be used in environments where sensitive information, such as legal documents, medical records, or financial data, is stored and accessed.

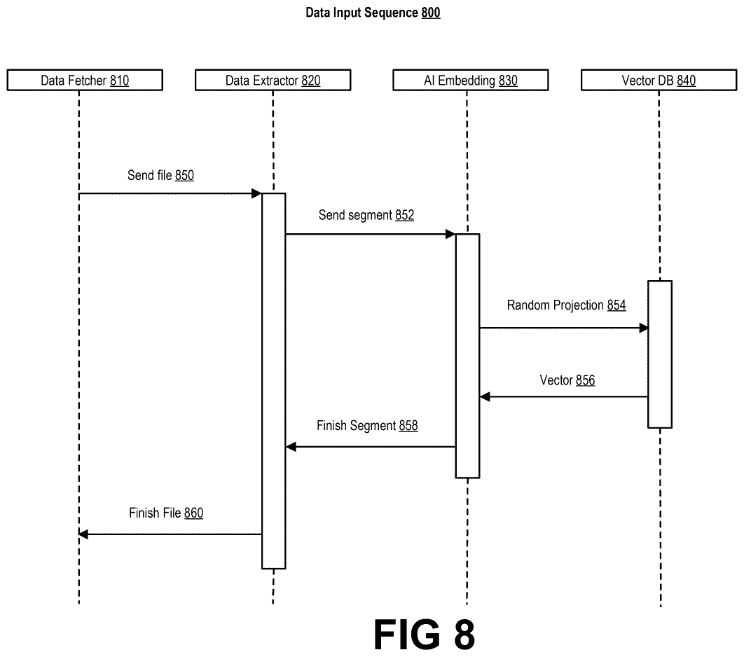

As illustrated in FIG. 8, a data input sequence 800 may set forth a process for handling data within the document management system 102. The data input sequence 800 may be used to manage, extract, and embed data in so that it is processed accurately and efficiently.

At step 850, the data input sequence 800 may include the data fetcher 810 transmitting a selected file to the data extractor 820 for detailed processing. The data fetcher 810 may efficiently locate and retrieve files from diverse storage environments, such as cloud-based storage systems or distributed data sources, so the necessary data is readily available for subsequent steps. This versatility in accessing various storage locations may enable the document management system 102 to handle a wide range of file types and formats, accommodating the dynamic and often decentralized nature of modern data management infrastructures. By seamlessly integrating with these storage environments, the data fetcher 810 may ensure that the data extractor 820 receives the correct file for further analysis and processing, laying the groundwork for the subsequent stages of the data input sequence 800.

At step 852, the data extractor 820 may segment the file and send the segments to the AI embedding 830. The data extractor 820 may break down the file into manageable content slices, allowing the AI embedding to process each segment individually. The segmentation may be based on semantic content by using one or more AI models to understand and maintain the contextual integrity of the text. According to some aspects, by preserving the integrity of the original file's semantic structure, the AI embedding 830 may generate accurate and meaningful high-dimensional embeddings for each content slice and enhance the overall effectiveness of the document management system 102.

At step 854, the AI embedding 830 may generate a high-dimensional random projection of the segment and send it to a vector database 840. The semantic content may be transformed into a format that can be efficiently stored and searched within the vector database. The AI embedding 830 may utilize one or more pre-trained NLP models to generate embeddings that encapsulate the semantic essence of the text, ensuring that the content can be accurately retrieved based on its meaning.

At step 856, the vector database 840 may process the random projection and return a corresponding vector to the AI embedding 830. The vector database 840 may maintain and manage high-dimensional embeddings, which may enable rapid and accurate searches. The vector database 840 may handle large volumes of data, utilizing optimized similarity algorithms to compare and retrieve the most relevant vectors.

At step 858, the AI embedding 830 may use the vector to refine the segment and then send the finished segment back to the data extractor 820. The AI embedding may refine its understanding of the content so that the final output is both accurate and contextually relevant. According to some aspects, fuzzy operations may be handled based on semantic similarity.

At step 860, the data extractor 820 may compile the finished segments into a complete file and send the complete file back to the data fetcher 810. This final step ensures that the processed data is ready for use, whether for storage, further processing, or transmission to other systems. The system's support for automated data analysis and its ability to generate content summaries from processed documents further enhance the usability of the final output, making it a powerful tool for managing complex data structures.

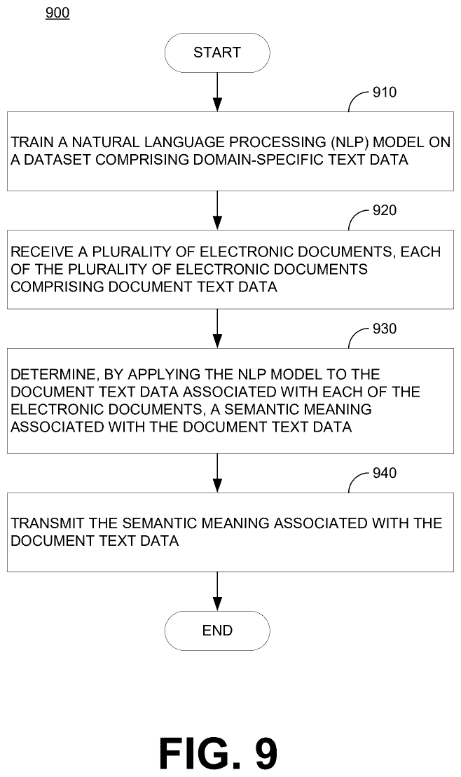

Referring now to FIG. 9, illustrated is a flowchart of a process 900, according to one example of the disclosed systems and processes. The process 900 may apply NLP techniques to analyze and surface semantic information from document text data.

At box 910, the process 900 may include training an NLP model on a dataset comprising domain-specific text data. This NLP model may be prepared by using a corpus of text data relevant to a particular field, such as legal, medical, or financial sectors. The training process may begin with the collection and organization of structured and/or unstructured data pertinent to the domain in question. The dataset may include legal contracts, case law, medical research papers, financial statements, and/or regulatory documents, depending on the field. A comprehensive corpus of domain-specific text data may be assembled and refined to prepare the NLP model for effective operation and so the NLP model accurately represents the linguistic patterns and terminology of the domain.

Once the dataset is prepared, the NLP model may undergo a training phase using supervised learning techniques. During the training phase, portions of the dataset may be labeled with specific information, such as key terms, entities, or relationships within the text, to guide the NLP model in learning how to classify, recognize, and understand the data. The NLP model may be exposed to various examples that teach the NLP model to identify patterns, contextual relationships, and the significance of terms within the domain. For example, in the legal domain, the NLP model may learn how to interpret terms such as “breach of contract,” “liability,” and “jurisdiction,” along with their context-specific meanings. Tho training phase may allow the NLP model to distinguish and understand complex linguistic nuances that differ across domains.

According to some aspects, the NLP model may undergo a pre-training phase on a large corpus of general language data. The pre-training may provide the NLP model with a broad understanding of language, including one or more of syntax, grammar, and/or basic semantic relationships. Moreover, general pre-training may enable the NLP model to comprehend fundamental aspects of human language before it is fine-tuned on the domain-specific dataset. Fine-tuning the NLP model on domain-specific text may specialize the NLP model and enhance the capability of the NLP model to surface relevant information by recognizing industry-specific terminology, jargon, and the contextual relationships associated with a targeted domain.

During the fine-tuning process, the pre-trained NLP model may adapt to the domain by refining its internal parameters through a supervised learning process to optimize its performance. Weights of the neural network may be adjusted based on labeled examples from the domain-specific dataset. Each layer of the model, including one or more transformer-based architectures like BERT or GPT, may utilize backpropagation to update the weights, optimizing the ability of the NLP model to capture relevant patterns, relationships, and/or context unique to the domain. The optimization process may employ one or more algorithms such as Adam or RMSProp, which may dynamically adapt the learning rate of the NLP model for convergence. Fine-tuning the NLP model may focus on one or more domain-specific linguistic features (e.g., key terminology, entity relationships, and/or context-dependent meanings), allowing the NLP model to enhance accuracy in identifying semantically relevant information. By continuously minimizing the loss function, which measures the difference between the predicted output of the NLP model and the true labels in the training data, the NLP model may become increasingly proficient at understanding the nuances of domain-specific language and provide high performance in tasks like document classification, entity recognition, and information retrieval within the targeted domain.

The NLP model may understand the general structure of human language while recognizing and prioritizing the semantics unique to the specific domain. The NLP model may be tailored to surface semantically relevant information from electronic documents and improve document retrieval and management efficiency, especially in fields where precision and contextual understanding are critical, such as legal or medical research.

At box 920, the process 900 may include receiving a plurality of electronic documents, each of the plurality of electronic documents comprising document text data. The electronic documents may be received from distributed data sources, such as local storage, cloud services, or other connected repositories. The documents may be presented in various format (e.g., DOC, PDF, or HTML). One or more pre-processing techniques may be applied to prepare the documents for analysis, such as converting different formats into a machine-readable structure and extracting the document text data. Optical Character Recognition (OCR) may be employed where necessary, particularly for scanned documents, to convert image-based text into digital text.

Once pre-processed, the document text data may be passed through a trained NLP model. The NLP model may handle complex semantic analysis, allowing the NLP model to extract meaning and context from the document content. For example, tokenization may be used to bread the text down into smaller units and embeddings, where each unit may be mapped into a high-dimensional space that captures its semantic properties. The NLP model may handle unstructured or semi-structured data, enabling the document management system to process various types of documents, including legal contracts, medical records, or financial reports. The NLP model may be fine-tuned on domain-specific corpora, which may provide accurate identification of relevant terms and relationships within the text.

According to some aspects, the NLP model may be trained on multilingual datasets, enabling the NLP model to recognize and accurately interpret text in different languages. Accordingly, the NLP model may capture the nuances of each language, ensuring that the meaning is preserved even in a cross-linguistic context. This multi-language capability may be especially useful in global applications, where documents may originate from various countries, and content in languages such as English, Spanish, French, and others may be encountered.

At box 930, the process 900 may include determining, by applying the NLP model to the document text data associated with each of the electronic documents, a semantic meaning associated with the document text data. The NLP model may process each document by analyzing its structure and linguistic features, such as sentence dependencies and latent topics. For example, the NLP model may break down complex textual data into high-dimensional representations (e.g., embeddings) that capture the semantic content of the document. The embeddings may reflect the meaning of individual words and phrases as well as the relationships between entities, actions, and key concepts within the text. For example, in a legal document, the NLP model may identify terms such as “contract,” “termination,” and “party” and understand their relevance based on the surrounding context.

The semantic meaning extracted from the document may be further refined by the NLP model, which may perform syntactic and contextual analysis to identify entities, relationships, and key events. This NLP model may recognize how different pieces of information are interconnected within the document, providing a more comprehensive understanding of the content. Moreover, the NLP model may use one or more machine learning algorithms, including attention mechanisms and transformer architectures, to weigh the importance of different terms relative to one another. For example, in a regulatory filing, the model may detect the critical relationships between compliance requirements, deadlines, and responsible entities.

Once the semantic meaning is represented as embeddings, similarity scores may be determined for each document based on how closely each document matches a given query. The similarity scores may be calculated using distance metrics applied to the embeddings. The documents may be ranked by relevance based on the similarity scores. Moreover, the embeddings may allow the system to retrieve relevant documents more effectively, even when the exact keywords or phrases are not present in the query. For example, if a user searches for documents related to “data privacy,” the document management system may surface documents discussing related topics such as “GDPR compliance” or “information security protocols.”

The ranked results may be provided to the user, allowing the document management system to efficiently surface the most contextually relevant information. By capturing nuanced semantic relationships, the embeddings may be used to handle large, complex datasets while maintaining accuracy and relevance in the information retrieval. According to some aspects, traditional keyword-based searches may be enhanced, providing a sophisticated, context-aware mechanism for managing and processing document collections.

At box 940, the process 900 may include transmitting the semantic meaning associated with the document text data. The semantic representations, such as high-dimensional embeddings or structured data outputs, may be transmitted to user interfaces or external systems. The external systems may include databases, regulatory form completion systems, or other automated processes. For example, the process 900 may transmit the semantic embeddings to a document management system that utilizes this information for ranking document relevance or automating document categorization.

The surfaced information may be displayed in a ranked list, providing users with content that is organized based on its relevance to a particular query or task. By leveraging the high-dimensional embeddings, similarity scores may be assigned that reflect how closely the documents'semantic meaning matches the user's query. The similarity scores may allow users to retrieve the most contextually appropriate documents or data points without a need for manually sifting through extensive data. Moreover, the ranking system may perform dynamic rankings based on user interactions or additional inputs from external systems.

In some scenarios, the semantic meaning of the document text data may be used to automatically generate structured data outputs. For example, natural language summaries of complex documents may be generated or regulatory forms (e.g., eSTAR forms) may be populated. The ability of the NLP model to extract the most relevant portions of text from large datasets may enable the document management system to efficiently fill in specific fields or generate reports that adhere to industry standards, such as legal or financial documentation requirements.

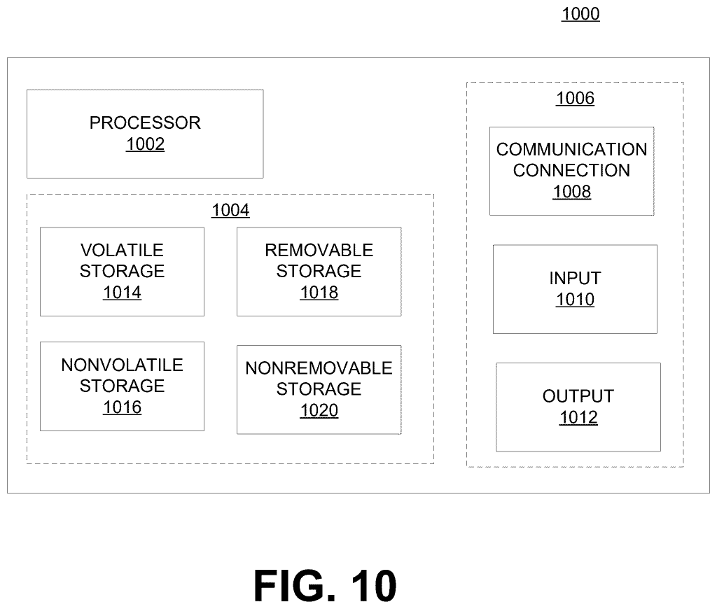

FIG. 10 is a block diagram of a computing device 1000 that may be connected to or comprise a component of environment 100. Computing device 1000 may comprise hardware or a combination of hardware and software. The functionality to surface relevant information from large datasets and collections of electronic documents may reside in one or a combination of computing devices 1000. Computing device 1000 depicted in FIG. 10 may represent or perform functionality of an appropriate computing device 1000, or a combination of computing devices 1000, such as, for example, a component or various components of a document management system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 10 is exemplary and not intended to imply a limitation to a specific example or configuration. Thus, computing device 1000 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 1000 may comprise a processor 1002 and a memory 1004 coupled to processor 1002. Memory 1004 may contain executable instructions that, when executed by processor 1002, cause processor 1002 to effectuate operations associated with a document management system. As evident from the description herein, computing device 1000 is not to be construed as software per se.

In addition to processor 1002 and memory 1004, computing device 1000 may include an input/output system 1006. Processor 1002, memory 1004, and input/output system 1006 may be coupled together (coupling not shown in FIG. 10) to allow communications between them. Each portion of computing device 1000 may comprise circuitry for performing functions associated with each respective portion. Thus, each portion may comprise hardware, or a combination of hardware and software. Accordingly, each portion of computing device 1000 is not to be construed as software per se. Input/output system 1006 may be capable of receiving or providing information from or to a communications device or other network entities configured for document management and surfacing information from electronic documents. For example, input/output system 1006 may include a wireless communication (e.g., 3G/4G/5G/GPS) card. Input/output system 1006 may be capable of receiving or sending video information, audio information, control information, image information, data, or any combination thereof. Input/output system 1006 may be capable of transferring information with computing device 1000. In various configurations, input/output system 1006 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 1006 may comprise a Wi-Fi finder, a two-way GPS chipset or equivalent, or the like, or a combination thereof.

Input/output system 1006 of computing device 1000 also may contain a communication connection 1008 that allows computing device 1000 to communicate with other devices, network entities, or the like. Communication connection 1008 may comprise communication media. Communication media may embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 1006 also may include an input device 1010 such as keyboard, mouse, pen, voice input device, or touch input device. Input/output system 1006 may also include an output device 1012, such as a display, speakers, or a printer.

Processor 1002 may be capable of performing functions associated with document management, such as functions for surfacing information from electronic documents, as described herein. For example, processor 1002 may be capable of, in conjunction with any other portion of computing device 1000, managing and processing electronic documents by training NLP models on domain-specific text data and employing advanced machine learning algorithms to manage and extract semantically relevant content from unstructured and structured text data, as described herein.

Memory 1004 of computing device 1000 may comprise a storage medium having a concrete, tangible, physical structure. As is known, a signal does not have a concrete, tangible, physical structure. Memory 1004, as well as any computer-readable storage medium described herein, is not to be construed as a signal. Memory 1004, as well as any computer-readable storage medium described herein, is not to be construed as a transient signal. Memory 1004, as well as any computer-readable storage medium described herein, is not to be construed as a propagating signal. Memory 1004, as well as any computer-readable storage medium described herein, is to be construed as an article of manufacture.

Memory 1004 may store any information utilized in conjunction with document management. Depending upon the exact configuration or type of processor, memory 1004 may include a volatile storage 1014 (such as some types of RAM), a nonvolatile storage 1016 (such as ROM, flash memory), or a combination thereof. Memory 1004 may include additional storage (e.g., a removable storage 1018 or a non-removable storage 1020) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 1000. Memory 1004 may comprise executable instructions that, when executed by processor 1002, cause processor 1002 to effectuate operations associated with document management.

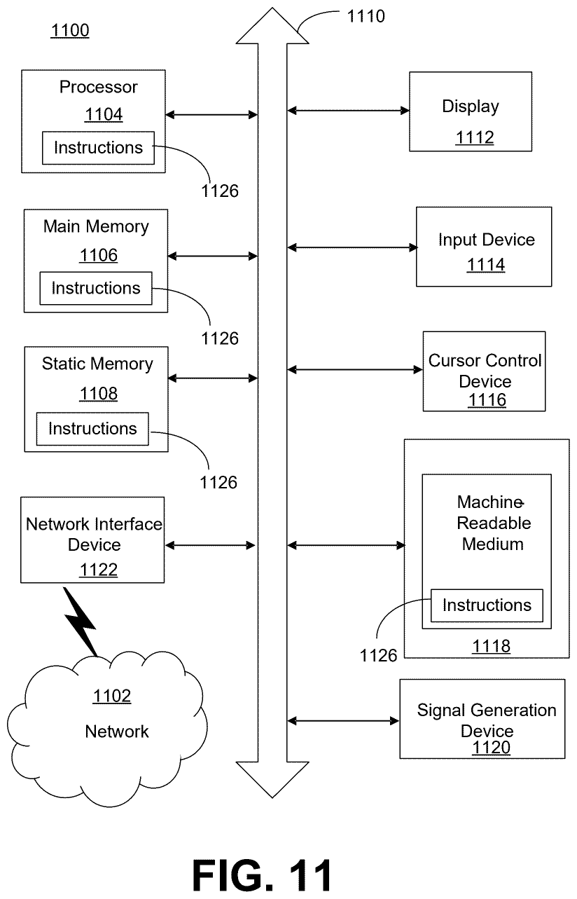

FIG. 11 depicts an exemplary diagrammatic representation of a machine in the form of a computer system 1100 within which a set of instructions, when executed, may cause the machine to perform any one or more of the methods described above. One or more instances of the machine can operate, for example, as processor 702, computing device(s) 104, server 108, database 110, and other devices of FIGS. 1-7. In some examples, the machine may be connected (e.g., using a network 1102) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 1100 may include a processor (or controller) 1104 (e.g., a central processing unit (CPU)), a graphics processing unit (GPU, or both), a main memory 1106 and a static memory 1108, which communicate with each other via a bus 1110. The computer system 1100 may further include a display unit 1112 (e.g., a liquid crystal display (LCD), a flat panel, or a solid-state display). Computer system 1100 may include an input device 1114 (e.g., a keyboard), a cursor control device 1116 (e.g., a mouse), a disk drive unit 1118, a signal generation device 1120 (e.g., a speaker or remote control) and a network interface device 1122. In distributed environments, the examples described in the subject disclosure can be adapted to utilize multiple display units 1112 controlled by two or more computer systems 1100. In this configuration, presentations described by the subject disclosure may in part be shown in a first of display units 1112, while the remaining portion is presented in a second of display units 1112.

The disk drive unit 1118 may include a tangible computer-readable storage medium on which is stored one or more sets of instructions (e.g., instructions 1126) embodying any one or more of the methods or functions described herein, including those methods illustrated above. Instructions 1126 may also reside, completely or at least partially, within main memory 1106, static memory 1108, or within processor 1104 during execution thereof by the computer system 1100. Main memory 1106 and processor 1104 also may constitute tangible computer-readable storage media.

While examples of a system for document management have been described in connection with various computing devices/processors, the underlying concepts may be applied to any computing device, processor, or system capable of facilitating document management. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for document management. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with document management as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing document management as described herein. When implemented on a general-purpose processor, the program code combines with the processor to provide a unique device that operates to invoke the functionality of a document management system.

While the disclosed systems have been described in connection with the various examples of the various figures, it is to be understood that other similar implementations may be used, or modifications and additions may be made to the described examples of a document management system without deviating therefrom. For example, one skilled in the art will recognize that a document management system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—training NLP models on domain-specific text data and employing advanced machine learning algorithms to manage and extract semantically relevant content from unstructured and structured text data—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising one or more processors, configured to:
train a natural language processing (NLP) model on a dataset comprising domain-specific text data;
receive a plurality of electronic documents, each of the plurality of electronic documents comprising document text data;
determine, by applying the NLP model to the document text data associated with each of the electronic documents, a semantic meaning associated with the document text data; and
transmit the semantic meaning associated with the document text data.

2. The one or more computing devices of claim 1, wherein the dataset comprises domain-specific text data including structured and unstructured text data from a specific industry or regulatory domain.

3. The one or more computing devices of claim 1, wherein the one or more computing devices are further configured to categorize the domain-specific text data into a plurality of knowledge domains and the NLP model is trained to recognize key terms and patterns associated with each knowledge domain of the plurality of knowledge domains.

4. The one or more computing devices of claim 1, wherein the dataset comprises a specific document type selected from a group comprising medical records, legal contracts, financial reports, or regulatory filings, and the NLP model is further trained to surface relevant information from the specific document type.

5. The one or more computing devices of claim 1, wherein the dataset comprises labeled training data and training the NLP model comprises applying supervised learning techniques based on the labeled training data.

6. The one or more computing devices of claim 1, wherein
the dataset further comprises user interaction data comprising a plurality of query types,
the NLP model is trained based on the user interaction data, and
the one or more computing devices are further configured to determine, based on the NLP model, one or more information types for each query type of the plurality of query types.

7. The one or more computing devices of claim 1, wherein the NLP model is pre-trained on general language data before being trained on the dataset comprising the domain-specific text data.

8. The one or more computing devices of claim 1, further configured to determine, based on the NLP model, one or more document sections associated with the semantic meaning of the document text data.

9. The one or more computing devices of claim 1, wherein the plurality of electronic documents are received from a plurality of distributed data sources.

10. The one or more computing devices of claim 1, wherein the document text data comprises text in a plurality of languages and the NLP model is trained to determine the semantic meaning of the document text data in each language of the plurality of languages.

11. The one or more computing devices of claim 1, further configured to apply, based on the semantic meaning, contextual embeddings to the document text data.

12. The one or more computing devices of claim 1, wherein determining the semantic meaning comprises identifying entities, relationships, or events in the document text data.

13. The one or more computing devices of claim 1, wherein determining the semantic meaning of the document text data comprises analyzing text structure, sentence dependencies, and latent topics within each of the plurality of electronic documents.

14. The one or more computing devices of claim 1, further configured to:
determine, based on the semantic meaning, a similarity score associated with a query;
determining, based on the similarity score, a ranking associated with the document text data; and
transmitting, based on the ranking, the document text data.

15. The one or more computing devices of claim 1, wherein determining the semantic meaning comprises identifying, based on a semantic similarity to a predefined category, a section of the electronic text document.

16. The one or more computing devices of claim 1, wherein the semantic meaning is transmitted to a user interface for display in a ranked list based on relevance to a query.

17. The one or more computing devices of claim 1, wherein the semantic meaning is transmitted to a database associated with automated form completion.

18. The one or more computing devices of claim 1, wherein the surfaced semantic meaning is used to generate a natural language summary of the document text data.

19. A method performed by one or more computing devices, the method comprising:
training a natural language processing (NLP) model on a dataset comprising domain-specific text data;
receiving a plurality of electronic documents, each of the plurality of electronic documents comprising document text data;
determining, by applying the NLP model to the document text data associated with each of the electronic documents, a semantic meaning associated with the document text data; and
transmitting the semantic meaning associated with the document text data.

20. A system comprising:
one or more processors; and
memory coupled with the one or more processors, the memory storing executable instructions that when executed by the one or more processors cause the one or more processors to effectuate operations comprising:
training a natural language processing (NLP) model on a dataset comprising domain-specific text data;
receiving a plurality of electronic documents, each of the plurality of electronic documents comprising document text data;
determining, by applying the NLP model to the document text data associated with each of the electronic documents, a semantic meaning associated with the document text data; and
transmitting the semantic meaning associated with the document text data.
